(19) United States
(12) Patent Application Publication
(10) Pub. No.: US 2021/0093948 A1
(43) Pub. Date: Apr. 1, 2021

(54) GENERIC COMPUTERIZATION SYSTEM FOR GAMES INVOLVING PHYSICAL INTERACTION, SPORTS AND SIMULATIONS

(71) Applicant: Christhian Henrique Gomes Fonseca, campinas - sp (BR)

(72) Inventor: Christhian Henrique Gomes Fonseca, Campinas (BR)

(73) Assignee: Christhian Henrique Gomes Fonseca, campinas -sp (BR)

(21) Appl. No.: 15/733,417

(22) PCT Filed: Feb. 7, 2019
(86) PCT No.: PCT/BR2019/050034

§ 371 Date: Jul. 23, 2020

(30) Foreign Application Priority Data
Feb. 21, 2019 (BR) BR102018003395-6

(51) Int. Cl. A63F 13/212; A63F 13/211; A63B 71/06; A63F 13/235

(52) U.S. Cl. CPC A63F 13/212; A63F 13/235; A63B 71/06; A63F 13/211

(57) ABSTRACT

The present patent application for Privilege of Invention, related to the fields of electronic games, data transmission by proximity, wearable technologies and sports, is essentially characterized by an electronic system capable of identifying and generating data related to physical events commonly associated with criteria and rules of sports and games of physical interaction, based on the physical proximity between objects and players. The interaction information between players and/or objects involved in the game is generated from electronic modules installed in them, which can communicate with each other when physically close and via radio with the software developed according to the application. This will process these events according to the rules of the game or sport in question, providing the results in a visual, sound or other method.

### APPLICATION FIELD

The aforementioned system, whose protection will be claimed in this report, was developed with the purpose of supplying deficiencies, alleviating difficulties and solving problems hitherto encountered by users of the sector, more precisely, electronic sectors, wearable technologies, entertainment, electronic games, sports, equipment for sports.

### Introduction

The present patent application for Privilege of Invention refers to a generic electronic computerization system for physical interaction games, sports and simulations, being more specifically an electronic system capable of identifying and generating data related to physical events commonly associated with criteria and rules for sports and physical interaction games.

The information on the interaction between players and objects involved in the game is generated from hardware modules installed in them, with the transmission of data of interest, such as object identification, region and impact intensity, from the object module (3) to the agent module (4) (player), which in turn treats this data, adding information of interest according to the application, such as identification of the player and affected region, and finally transmitting all this data to a communication central that does the interface with the software developed according to the application.

It will process the data according to the rules of the game or sport, providing the results in visual, sound or other methods, the central also receives data from the software, being able to forward them to modules of specific agents and objects, enabling feedback in real-time results of processing the event occurred.

Said system stands out, fundamentally, for the most practical, simple and functional way to an electronic system capable of identifying and generating data related to physical events commonly associated with criteria and rules of sports and physical interaction games, the same being endowed with unique, exclusive and innovative functional aspects, which will be described below.

### Features

The system in question, presented through this report, consists of: three types of basic modules: Object Modules, Agent Modules and Communication Central.

Object module (3): are the elements of the system that during the game, game or simulation send data by magnetic coupling (or other methods) when a triggering event is detected (by its sensors (2), buttons, etc.) and this data can be received by agent modules that are close enough to magnetically couple.

It consists of coil arrangements (1) (or other elements related to the method of exchanging information between the agent (4) and the object (3)) connected to an electronic circuit (electronic central) that will excite them according to the information to be sent. There are also sensors (2) according to the application, providing the data that the central needs to define when and what information should be sent through the coil arrangements (1).

Finally, it is possible to connect to the Communications Central to allow the configuration of objects to be included in the system. Because it is a necessary connection only at the moment of the object's initialization (and not during the match) it can be made through wires, but, depending on the application, one can choose to make it through wireless connection methods.

It can be installed on a surface of the arena or scenario where you want to determine when it is stepped on or touched by a player, using different coil arrangements (1) and sensors (2) to define each region of interest.

In objects used by one player to hit another (such as simulations of melee weapons, shoes, shin guards, knee pads, gloves, elbow pads and helmets) with coil arrangements (1) arranged on the object so that it identifies which player is carrying the object and which is being hit and by which part of the object, in addition to the intensity of the impact (provided by sensors (2) such as accelerometers or piezoelectric elements).

On objects that are placed, thrown, kicked and fired (such as balls, arrows, discs) in certain regions of the arena, field, court or scenario (with Agent module (4) installed, such as goalposts, nets, baskets, targets). Also, on projectiles fired to hit other players.

Agent Module (4): these are the elements of the system that during the game/game/simulation receive data from the Object modules via magnetic coupling (or other methods) and send and receive information from the Communication Central via an RF transceiver (or other methods).

It consists of coil arrangements (1) (or other elements related to the method of exchanging information between the agent module (4) and the object module (3)) connected to an electronic circuit (electronic central) that will handle the signal received by one of these arrays, decoding the information contained therein, in addition to determining which array received this signal.

In this circuit there is a microcontroller that processes this received information, being able to add data from its memory (such as player identifiers) or generated from the processing of the signal from sensors (2) present in the agent module according to the application (for example, example: accelerometers, gyroscopes, thermometers, piezoelectric sensors), sending this entire data package through an RF transceiver and finally, there are feedback devices according to the application (LEDs, buzzers, speakers, augmented reality glasses or reality virtual) that are triggered according to commands or data received by the microcontroller through the RF transceiver from the Communication Central.

It can be installed in the players' clothes, shoes and/or protective equipment, with their coil arrangements (1) distributed according to the regions of the body where it is desired to detect and locate contact with other objects or surfaces relevant to the game.

On vehicle surfaces to detect their collision with specific objects or specific regions of a track or path and in certain regions of the arena, field, court or scenario (such as beams, nets, baskets, targets) where you want to detect that an object was put, thrown, kicked and fired.

Communication Central: it is the element of the system that sends and receives data from the Agent modules through an RF transceiver and connects to the computer where the software of the desired application is working, communicating with it.

They can also send data by magnetic coupling to Agent modules for initialization and other specific application needs and can also communicate with object modules, to allow the configuration of those to be included in the system.

It consists of an electronic central that has a connection to a computer (for example USB) through which it communicates with the software of a specific application, it has an RF transceiver connected to the central where it sends and receives data from the Agents units and to execute communications configuration and registration of Agent modules, also has coil arrangements (1).

Finally, it has a connection for communication with object modules to allow the configuration of those to be included in the system, as it is a necessary connection only at the moment of object initialization (and not during the start-up) it can be made through wires, but, depending on the application you can choose to perform it through wireless connection methods.

The electronic central has a microcontroller that decodes, processes and forwards information from Agent modules, weapons modules and software.

Depending on the application, you can combine Object modules and Agent modules in the same physical object, for example: projectiles containing an Agent module (4) to receive data from the object that fired it and an Object module (3) to send data to the physical objects that they reach (which must have Agent modules installed).

Objects used by a player and that are attached to him so that only he is able to use (for example, shoes, shin guards, knee pads, gloves, elbow pads), in this case there is no need for coil arrangements (1) and transmission of data by magnetic coupling of these objects to the Agent module (4) of the player who is carrying them, since the identification of the object is already sufficient to determine the player (as long as previously configured).

Objects used by a player, but not fixed to it, and which must generate data from the interaction with other objects (for example, shields) and in this case there is an Agent module (4) to receive the data of the object with which there is interaction and an Object module (3) to transmit data to the Agent module (4) of the player who is carrying it.

Because they are attached to the same physical entity, they can be electrically interconnected by wires, either to share energy sources, to communicate between modules or even to use the same microcontroller. In addition, the same coil arrangement (1) can be used both for receiving (agent module (4)) and for sending (object module (3)) of data by magnetic coupling.

### FIGURES

Initially, in order to better demonstrate these characteristics, and aiming at a clear and objective understanding about the provisions applied in the present invention privilege, drawings in a demonstrative character will be presented, making references to the report that are attached.

FIG. 1 illustrates the flowchart of the object module (3).

FIG. 2 illustrates the flowchart of the agent module (4).

FIG. 3 illustrates the flowchart of the communication central.

FIG. 4 illustrates the flowchart of the electronic module of the Agent module (4) connected to the coil arrangement (1) and this finally connected to the electronic module of the Object module (3).

FIG. 5 illustrates an example of an application where you want to detect when a specific player is over a specific region (6), in the player's shoes there are coils (1) installed and connected to the Agent module (4) and on the floor there are two coil arrangements (1) delimiting two different regions, in addition to impact sensors (2), all connected to an Object module (3).

FIG. 6 illustrates an example of an application where you want to identify which specific player threw or grabbed a particular object, in the palm of the player's glove there are coils (1) installed and connected to the Agent module (4) and below the surface of the object are installed coils (1), in addition to a motion sensor (2) (such as accelerometers), all connected to an Object module (3).

FIG. 7 illustrates an example of an application where you want to identify which specific player used a particular object capable of firing other objects (projectiles) which can hit another specific player in a certain region (6) of the body, in the region (6) where if the object must be held (for example, in the grip of a gun) coils are installed (1), as well as in the region (6) in which this object is in contact with the object to be projected, in addition to the Object module (3) with some type of sensor (2) that informs you when the object will be fired and the object to be projected has a combination (5) of the Agent (4) and Object (3) module, in addition to coils (1) and an impact sensor (2).

FIG. 8 illustrates an example of an application where it is desired to detect when a specific player is hit in a specific region (6), by a specific region (6) of a particular object used by a specific player, in the player's dress there are several arrangements of coils (1) installed and connected to the Agent module (4), which delimit the different regions of the player's body and in the object there are other arrangements of coils (1) delimiting different regions of the object, in addition to impact sensors (2), all connected to an Object module (3).

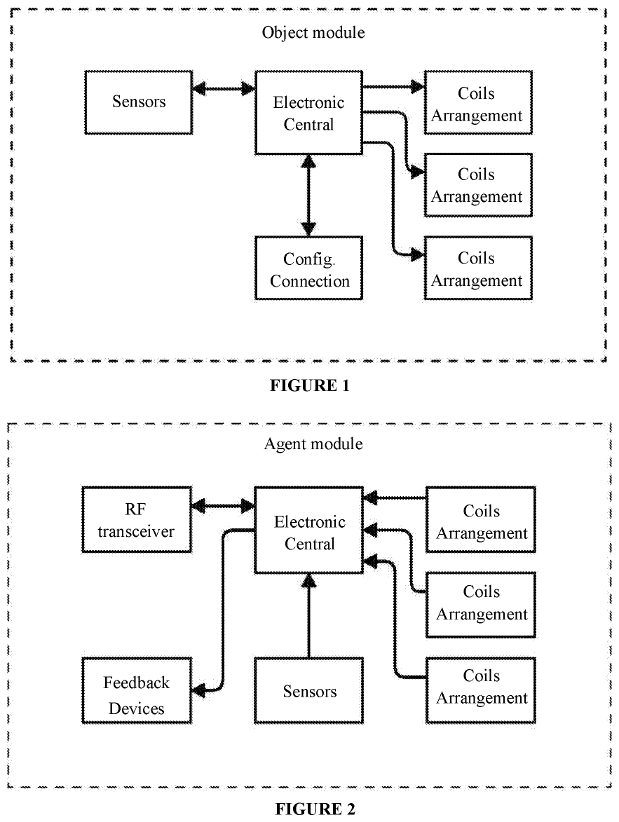

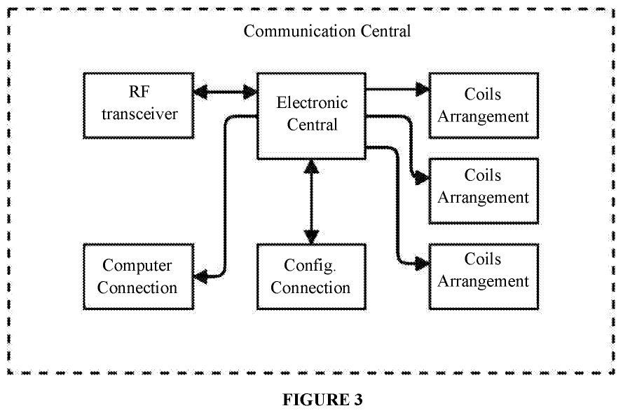

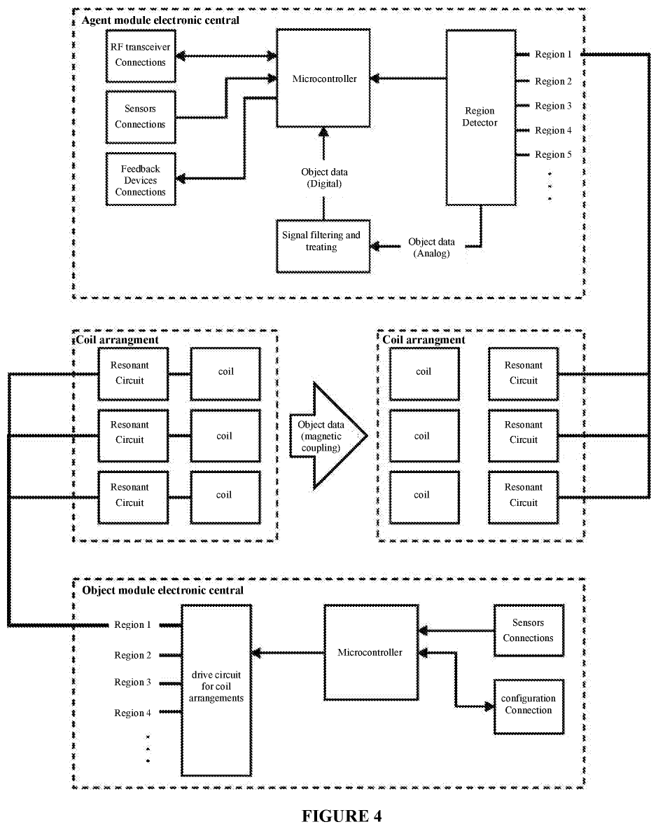

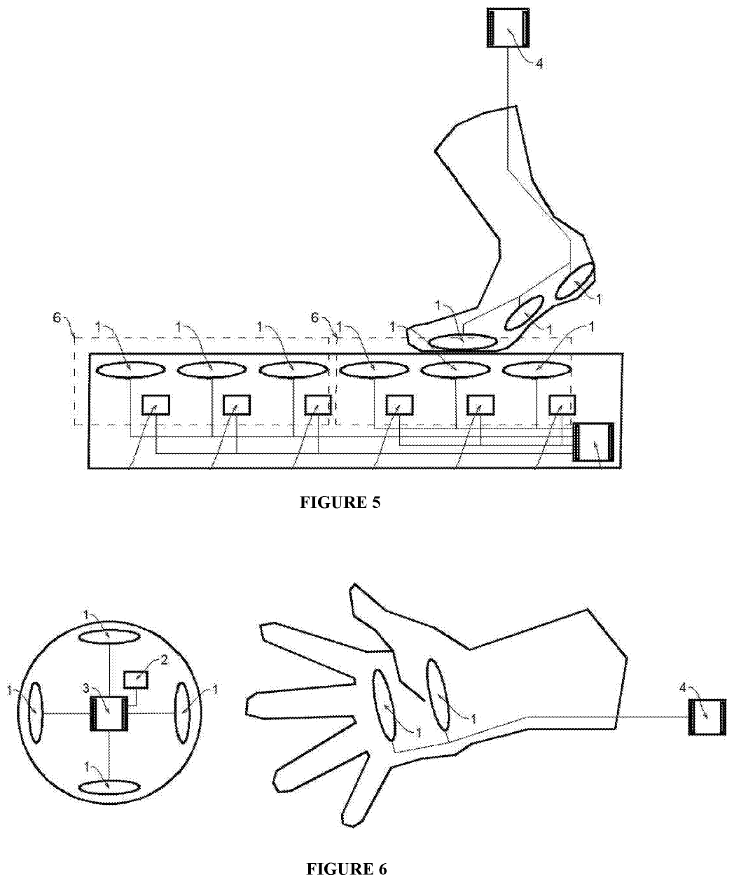

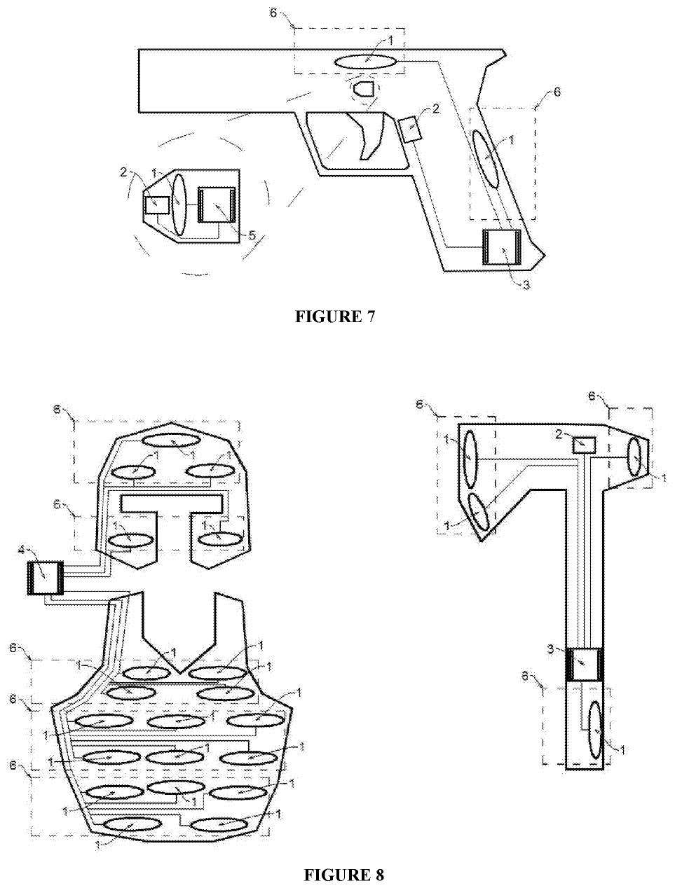

It should be noted that the images listed above illustrate the system in a demonstrative and non-restrictive manner, the design of which may vary in terms of its measures, raw material, dimensions, etc., without logically departing from the main scope whose protection is claimed.

### Functionality

Initially, the referred system, described by means of this report, will be used in the electronic, wearable technologies, entertainment, electronic games, sports, sports equipment.

The objects used in a particular sports practice, fight or physical interaction game and which want to detect their interactions with the players, receive the installation of Object modules.

Players, vehicles or other items in which it is desired to detect interactions with objects, receive the installation of Agent modules, there are also certain objects that must receive the combination (5) of these modules, either because their operation is based on interaction with players and objects (as in the case of an object fired from another object to hit a player) or for reasons of application optimization (as in the case of fixed objects to players).

The Communication central must be connected (or integrated) to a computer where the software will work, the algorithms of this software are developed according to the application, in order to analyze the events that occurred according to the rules and criteria of the game in question, making available the audiovisual resources of interest, using the technologies available for this purpose.

Initial configuration: The software is started on a computer (consoles, etc.) and will search for the Communication central, which must be connected to this same computer, until a stable connection is established.

In the first use of an object, its Object module (3) must be configured, for this there is a connection in the communication central, this configuration consists of saving in the memory of the Object module microcontroller (3) some identifiers generated by the software, normally operated by a user, so that the user is able to identify which type of object among the types existing in the application and which is the specific object among other objects of the same type, in addition to other identifiers that may vary with the type of object and with the needs of the application and if the objects are to be used several times by the same software, it can keep a record of them so that a new initialization of these objects is not necessary for the next use.

Similarly, players (vehicles or other objects) must also be initialized, it is possible to create accounts for them with their personal data, where the name will be important for the understanding of events that have occurred, by users or possible audience, this account can give access to statistics, histories, properties, attributes, etc. and it is through this that the reference is made to the Agent module (4) installed on the vest or equipment used by the player, that is, by magnetic coupling (or other transmission method) data) via the Communication central, the software must send at least one identifier to the Agent module (4) used by the player who has just accessed his account in order to be able to relate a player registered in the software with the Agent module (4) used by him at a given time.

Finally, the software must be configured by the user according to the available options, developed according to the specific application, allowing, for example, the selection of rules for the match, duration, team formation and purchase of items. game.

Functioning during the game/game: the functioning of the system during the game can change a lot according to the application, but in general, there are some information flows between the modules that cover most events of interest, from which you can—analyze what is happening, applying the rules and criteria of the sport or game in question.

To understand the flows, there are some basic definitions: trigger event—most information flows start with a trigger event of the Object module (3) or the Agent module (4), a trigger event can be the close or open contacts or even when the measurements sent by a certain sensor (2) exceed a certain limit, indicating to the module that a message must be sent, in addition to what data must compose this message; magnetic coupling message—messages sent from the Object modules to the Agent modules through the magnetic coupling of their coil arrangements (1) that are physically close (up to 5 cm), must contain information about the type of object, unique identifier among objects of the same type, type of event, contact region (6) of the object and quantities related to the measurements made by the sensors (2) of the Object module (3); radio frequency message—are messages sent from the Agent modules to the Communication central and from the Central to the Agent modules through radio frequency transceiver modules, contains information about the type of message and identification of the sender, in the case of radio frequency messages sent by the Agent modules due to the interaction with an object module (3), these contain all the information received from the object module in addition to the information about which coil arrangement (1) of the Agent module (4) received the information, from in order to determine the region where there was contact, and also data from sensors (2) of the agent module (4) that are of interest.

During the game, the following information flows occur: Object>agent>central: the Object module (3) detects a triggering event through its sensors (2) and sends a message by magnetic coupling to the Agent module (4) that is in contact or close, the latter sends a message to the central radio frequency containing all information about the event.

This is the flow of information used in events such as: player in contact with a specific region of the scenario or arena; player in contact with a specific region of the scenario or arena.

Object>agent 1>central>agent 2>central: the Object module (3) detects a triggering event through its sensors (2) and sends a message by magnetic coupling to Agent modules that are in contact or close to two different regions of the object, the Agent modules send radio messages to the central containing all information about the two events.

This is the flow of information used in events such as: a player uses an object to reach another player.

Object A>agent 1>object B>agent 2>central: the Object module (3) A detects a triggering event through its sensors (2) and sends a message by magnetic coupling to the Agent module (4) 1 that is connected to the object module (3) B, as they are physically installed in the same object or player, the Object module (3) B receives a triggering event through the Agent module (4) 1 and sends a message by magnetic coupling to the Agent module (4) 2 that is in contact or close and the latter sends a message via radio frequency containing all information about the event.

This is the flow of information used in events such as: player using an object to block another object.

Object A>agent 1>object B>agent 2>central>agent 3>central: the Object module (3) A detects a trigger event through its sensors (2) and sends a message by magnetic coupling to the Agent module (4) 3 and another to the Agent module (4) 1, which is connected to the object module (3) B, since they are physically installed in the same object or player, the Object module (3) B receives a trigger event through the Agent (4) 1 module and sends a message by magnetic coupling to the Agent (4) 2 module that is in contact or close and the Agent 2 and 3 modules send the central radio frequency messages containing all information about the two events.

This is the flow of information used in events such as: player using an object capable of shooting other objects to reach another player.

Agent>central: the agent module (4) detects a triggering event through its sensors (2) and sends a radio frequency message to the central containing all information about the event.

This is the flow of information used in events such as: player moves from standing to crouching or lying down; player performs a certain move.

Inform the battery level of the modules: all information received by the Communication central is transmitted to the software that will analyze the events according to the rules of the sport or game, being able to send messages to the agent modules, through the Central, to update information or even act in feedback media present in these modules, such as LEDs, buzzers, displays, speakers, etc.

### Innovation

In general terms, this system represents a solution with regard to a generic electronic computerization system for physical interaction games, sports and simulations.

It is a unique, exclusive and innovative system, being highly reliable and recommendable for use in its moment of offering an even greater depth by allowing games, along the lines of virtual games, to be played physically, mixing the objectivity of results, range of possibilities and immersion of the virtual with the energy, interaction and emotion of the physical world, in addition to the creation of these physical interaction games and simulators, technology can offer a reformulation of existing sports practices, allowing automatic and objective evaluations of multiple events, elimination or decrease in the need for referees, judges and juris, in addition to results in real time with audiovisual responses, even allowing the expansion of the number of simultaneous players in fights and martial arts without the need for judges or auxiliaries.

The system is able to compute and process data related to events of interest for various sports and physical games (not directly virtual), allowing the realization of these to be analyzed and processed by software, which can provide results of these events by audiovisual means, including through devices ported by players.

In general, the rules or criteria for evaluating games, sports and simulations is based on physical contact between players, between objects and between players and objects and certain characteristics and properties of these players and objects at a given moment, so that a system to be able to process these events it is necessary to provide information about the players and specific objects involved in a given contact, in addition to their characteristics and properties of interest at the time of contact.

Sending data about the characteristics and properties of a player or object is not a great difficulty today, given the enormous offer of wireless connections and sensing means available on the market, even at low cost, the difficulty lies in determining specifically which two objects or players, among several other objects and players, came into contact with each other at a certain moment, including information about the characteristics of that contact (for example, region (6) of the player and object, intensity of impact).

Based on the available technologies, there are two basic approaches that make it possible to obtain this information for real-time computational use: spatial (three-dimensional) location of the surfaces of players and objects and transmission of identification data between players and objects.

The spatial (three-dimensional) location of players and objects can be performed using GPS, triangulation of antennas, cameras, movement from a starting point (using a magnetometer, accelerometer and gyroscope), in addition to other methods, in general this approach is not very viable because due to the possibility of a high number of players and mainly objects, added to the fact that one must specifically locate each part of these (which can move among themselves), increasing the number of locations to be informed, it is necessary that the system uses low-cost and low-cost computational processing methods, a restriction that limits to low-precision spatial localization solutions, incompatible with the needs of the system.

The transmission of identification data between players and objects can be carried out through contact between conductive surfaces, infrared transceivers, RFID tags, barcode readers, in addition to other methods, the use of conductive surfaces and infrared transceivers preclude the generic installation of modules in several objects, as these methods require certain characteristics of the surfaces of the objects where they would be implanted, being necessary great alterations of these (mainly visual), besides that damages caused to this surface due to the contact between objects, could cause the non-functioning of the objects. modules.

Finally, the use of RFID tags available on the market also have important limitations, active RFID tags have a high cost and since they must cover the entire surface of players and objects where you want to identify the contact, their use makes your application too expensive, in addition to that in general are read at greater distances in a way that could accuse the contact of an object from regions of a player in addition to those that were actually reached, from the passive RFID tags available on the market, only the low frequency ones (125 kHz-134 kHz) have reading at a limited enough distance to avoid reading unreached regions, however due to the time it takes to read the data (adding the time for energization and verification following the existing protocols), quick contacts between objects and players (such as, in hits of blows or projectiles) would not be identified and, moreover, like any surface of objects identifiable by the system it should contain tags, each one having a unique identification, the initialization of objects and players would be extremely laborious, and each tag should be read individually and linked by a user to a specific region (6) of a specific player or object in the software.

Then a method was developed to specifically determine which two objects or players, among several other objects and players, came into contact with each other at a given moment, including information on the characteristics of that contact through the transmission of identification data between players and objects by coupling between coil arrangements (1).

Basically there is a receiver module (which integrates the Agent modules) with a number of reception channels equal to the number of different regions that this module must detect and a transmitter module (which integrates the Object modules) with a number of emission channels equal to the number of distinct locations through which it is able to emit the signal containing the data to be transmitted.

A coil arrangement (1) with a number of coils (1) sufficient to cover the surface area of the region (6) that is desired to detect the dimensions of these coils (1) is determined by each receiving or emitting channel (1). size of the smallest detectable regions of interaction, seeking similar sizes and shapes between reception and emission coils (1) in order to obtain a better magnetic coupling, as high reception intensity levels are not desirable, in order to limit the distance of reception in less than 5 cm, the coils (1) are made of very thin enameled copper wires with up to 30 turns, so they form light and flexible arrangements that can be easily installed on objects of interest without drastic changes.

When the microcontroller of the Object module (3) detects a certain event through its sensors (2), which must be transmitted to nearby Agent modules, after the encoding of the respective messages (containing information about the event, types of messages, object identifiers and contact region (6), battery level, etc.), it activates the activation circuit of the coil arrangements (1) of the appropriate regions, which switch the excitation at a certain frequency in the coils (1) according to encoding of the message to be sent, which is short to meet the speed demand, containing no more than 20 bits.

The coil arrays (1) of Agent modules that are close to the coil arrays (1) driven from the object module (3) emitting, are magnetically coupled, receiving the signal containing the transmitted information, in the electronic control module. Agent (4), there is a region detector (6) that informs the microcontroller through which channels this signal was received, there is also a circuit for filtering and processing that signal that sends the received message already digitized to the microcontroller and based on the type of message received, the microcontroller adds relevant information (such as Agent identifier, contact region (6), message types and data obtained from sensors (2) of the agent module (4)) generating a new message that is sent to the central communications via the RF transceiver.

### Description of the State of the Technique

During the development of this system, numerous researches were carried out to identify the existence of possible priorities or similar systems. Such surveys, however, did not indicate the existence of any other system with the same predominant or functional technical characteristics.

The System brings a practical, comprehensive and easy-to-install solution in sports clothing and equipment, offering an even greater depth by enabling games, along the lines of virtual games, to be played physically, mixing objectivity of results, range of possibilities and immersion of the virtual with the energy, interaction and emotion of the physical world, in addition to the creation of these physical interaction games and simulators, technology can offer a reformulation of existing sports practices, allowing automatic and objective evaluations of multiple events, eliminating or reducing the need for referees, judges and juris, in addition to real-time results with audiovisual responses, even allowing the expansion of the number of simultaneous players in fights and martial arts without the need for judges or auxiliaries.

Today, with the enormous advancement and mastery of information technology, our need for entertainment has been increasingly met by activities that do not involve or involve little physical activity.

Among these activities we have electronic games and simulators, which with increasing processing and graphic quality, offer us a visual experience very close to reality, so that traditional sports practices are becoming less attractive to new generations, culminating in sedentary lifestyle and problems resulting from it.

Despite some products on the market that involve some more significant physical action, such as console controls with motion sensors, it seems that the trend is an increasing search for virtual entertainment, so that the body, evolved to function in motion, has more and more less direct functionality in these actions.

Therefore, the application of the system in sports and new physical interaction games can attract people, especially the new generations, to practice physical activities, being a good tool in the fight against physical inactivity.

There is no system in the market for real-time analysis of different sports and games, of low cost and easy implantation in sports and generic equipment to meet a diverse range of applications.

Finally, as this system processes event data in its modules and provides all information at the end of the process through a small 32-bit digital message, easily processed by any computer or console, it is possible to easily develop software developed to meet different applications.

Given this need and commercial opportunity, the aforementioned system was created, more precisely a generic electronic computerization system for physical interaction games, sports and simulations, being more specifically an electronic system capable of identifying and generating data related to physical events commonly associated with criteria and rules for sports and physical interaction games.

Therefore, in accordance with article 8 of the Industrial Property Law No. 9,279/96 and for all aspects presented in this report, the object of the present patent application is worthy of protection as an Invention Privilege, which is now claimed.

1. GENERIC COMPUTERIZATION SYSTEM FOR PHYSICAL INTERACTION GAMES, SPORTS AND SIMULATIONS—It is a generic electronic computerization system for physical interaction games, sports and simulations, which allows the generation of data on events, based on physical proximity, that occurred between objects, agents, vehicles, areas of arenas and scenarios, etc. and is characterized by the fact of comprising:
at least one object module (3) comprising:
a micro controlled electronic circuit that stores and generates information and attributes of the object, processes information from sensors (2) or buttons, composes messages from this information and activates different channels to which coil arrangements are connected, which are excited according to the message that each channel should send with information of interest (type of message, type of object, object identifier, mode of operation, impact intensity, point of impact on the object, region/channel of sending, battery level),
at least one coil arrangement (1) that will transmit the generated message by magnetic coupling,
at least one sensor (2) or button that informs the electronic circuit of the occurrence of a triggering event, and
a connection for initial configuration of the object module (3) with the communication central (5);
at least one agent module (4) comprising:
a micro controlled electronic circuit that stores and generates information and attributes of the agent (player, vehicles, parts of an arena or scenario, robots, etc.), processes information from sensors (2) or buttons, treats and decodes messages received by different coil arrangements (1) connected to its channels, determines by which channel a given message was received, sends and receives information from the communication central (5) through an RF transceiver and activates feedback devices such as LEDs, buzzers or other audiovisual means for report the status of agent attributes in real time,
at least one coil arrangement (1) that will receive by magnetic coupling the messages sent by the coil arrangement of nearby object modules,
at least one sensor (2) or button that informs the electronic circuit of the occurrence of an event of interest, position of the agent or input of commands, and
an RF transceiver that allows the exchange of messages with the communication central (5);
a communication central (5) comprising:
a micro-controlled electronic circuit that decodes, processes and routes information from agent modules (4), object modules (3) and software,
an RF transceiver that allows the exchange of messages with the agent modules (4),
a connection for initial configuration of the object module (3) with the communication central (5), and
at least one connection to the device or computer where the software developed according to the desired application is executed and which uses the information generated by the system about the physical events that occurred to generate the results.

2. GENERIC COMPUTERIZATION SYSTEM FOR PHYSICAL INTERACTION GAMES, SPORTS AND SIMULATIONS—This is a generic electronic computerization system for physical interaction games, sports and simulations, as described in claim 1, characterized by the fact that it comprises:
at least one combined module comprising the union of the elements and functions of said object module (3) and agent module (4) so that it is possible for an object or agent, equipped with this module, to receive messages from object modules and send messages to agent modules.

3. GENERIC COMPUTERIZATION SYSTEM FOR PHYSICAL INTERACTION GAMES, SPORTS AND SIMULATIONS—This is a generic electronic computerization system for physical interaction games, sports and simulations, as described in claim 1, characterized by the fact that it comprises:
said object module (3) which additionally comprises:
an RF transceiver that allows the exchange of messages with the communication central (5).

4. GENERIC COMPUTERIZATION SYSTEM FOR PHYSICAL INTERACTION GAMES, SPORTS AND SIMULATIONS—This is a generic electronic computerization system for physical interaction games, sports and simulations, as described in claim 1, characterized by the fact that it comprises:
said communication central (5) which additionally comprises:
at least one coil arrangement (1) that will transmit messages by magnetic coupling to agent modules (4) for initialization or configuration or for other specific application needs.
